(19) United States
(12) Patent Application Publication
(10) Pub. No.: US 2022/0319050 A1
(43) Pub. Date: Oct. 6, 2022

(54) CALIBRATION METHOD AND APPARATUS, PROCESSOR, ELECTRONIC DEVICE, AND STORAGE MEDIUM

(71) Applicant: SHANGHAI SENSETIME INTELLIGENT TECHNOLOGY CO., LTD., Shanghai (CN)

(72) Inventors: Xiang MU, Shanghai (CN); Danpeng CHEN, Shanghai (CN)

(21) Appl. No.: 17/836,093

(22) Filed: Jun. 9, 2022

Related U.S. Application Data
(63) Continuation of application No. PCT/CN2020/083047, filed on Apr. 2, 2020.

(30) Foreign Application Priority Data
Dec. 31, 2019 (CN) 201911420020.3

(51) Int. Cl. G06T 7/80; H04N 5/232

(52) U.S. Cl. CPC G06T 7/80; H04N 5/23258

(57) ABSTRACT

A calibration method includes: at least two poses of an imaging device are acquired, and at least two pieces of first sampling data of an inertial sensor are acquired; spline fitting process is performed on the at least two poses to obtain a first spline curve, and spline fitting process is performed on the at least two pieces of first sampling data to obtain a second spline curve; and time-space deviation between the imaging device and the inertial sensor is obtained according to the first spline curve and the second spline curve, where the time-space deviation includes at least one of a pose conversion relationship or a sampling time offset.

### CROSS-REFERENCE TO RELATED APPLICATIONS

The application is a continuation of International Application No. PCT/CN2020/083047, filed on Apr. 2, 2020, which claims priority to Chinese Patent Application No. 201911420020.3, filed on Dec. 31, 2019. The disclosures of International Application No. PCT/CN2020/083047 and Chinese Patent Application No. 201911420020.3 are hereby incorporated by reference in their entireties.

### BACKGROUND

Various specific functions may be realized based on data acquired by a imaging device and data acquired by an inertial sensor. Due to pose deviation between the imaging device and the inertial sensor, or sampling time deviation between the imaging device and the inertial sensor, the effect based on the specific function realized by the imaging device and the inertial sensor is not good. Therefore it is of great importance on how to determine time-space deviation (including at least one of the pose deviation or the sampling time deviation) between the imaging device and the inertial sensor.

### SUMMARY

The disclosure relates to the technical field of computers, in particular to a calibration method and apparatus, a processor, an electronic device, and a storage medium.

Embodiments of the disclosure provide a calibration method and apparatus, a processor, an electronic device, and a storage medium.

According to a first aspect, an embodiment of the disclosure provides a calibration method including the following operations. At least two poses of an imaging device are acquired, and at least two pieces of first sampling data of an inertial sensor are acquired. Spline fitting process is performed on the at least two poses to obtain a first spline curve, and spline fitting process is performed on the at least two pieces of first sampling data to obtain a second spline curve. Time-space deviation between the imaging device and the inertial sensor is obtained according to the first spline curve and the second spline curve, the time-space deviation includes at least one of a pose conversion relationship or a sampling time offset.

According to a second aspect, an embodiment of the disclosure further provides a calibration apparatus including a memory storing processor-executable instructions, and a processor. The processor is configured to execute the stored processor-executable instructions to perform operations of: acquiring at least two poses of an imaging device, and acquire at least two pieces of first sampling data of an inertial sensor; performing spline fitting process on the at least two poses to obtain a first spline curve, and performing spline fitting process on the at least two pieces of first sampling data to obtain a second spline curve; and obtaining time-space deviation between the imaging device and the inertial sensor according to the first spline curve and the second spline curve, the time-space deviation comprising at least one of a pose conversion relationship or a sampling time offset.

According to a third aspect, an embodiment of the disclosure further provides a non-transitory computer-readable storage medium having stored thereon computer-executable instructions that, when executed by a processor, cause the processor to perform operations of: acquiring at least two poses of an imaging device, and acquire at least two pieces of first sampling data of an inertial sensor; performing spline fitting process on the at least two poses to obtain a first spline curve, and performing spline fitting process on the at least two pieces of first sampling data to obtain a second spline curve; and obtaining time-space deviation between the imaging device and the inertial sensor according to the first spline curve and the second spline curve, the time-space deviation comprising at least one of a pose conversion relationship or a sampling time offset.

It should be understood that the foregoing general description and the following detailed description are exemplary and explanatory only, and are not intended to limit the disclosure.

### BRIEF DESCRIPTION OF THE DRAWINGS

In order to explain the technical solutions in the background or the embodiments of the disclosure more clearly, the drawings which are intended to be used in the background or the embodiments of the disclosure will be described below.

Here the drawings are incorporated in and constitute a part of the description, and illustrate embodiments consistent with the disclosure, and together with the description, serve to illustrate the technical solutions of the disclosure.

FIG. 1 is a first schematic flowchart of a calibration method according to an embodiment of the disclosure;

FIG. 2 is a schematic diagram before and after performing spline fitting process on an angular velocity of an inertial sensor according to an embodiment of the disclosure;

FIG. 3 is a second schematic flowchart of a calibration method according to an embodiment of the disclosure;

FIG. 4 is a third schematic flowchart of a calibration method according to an embodiment of the disclosure;

FIG. 5 is a fourth schematic flowchart of a calibration method according to an embodiment of the disclosure;

FIG. 6 is a fifth schematic flowchart of a calibration method according to an embodiment of the disclosure;

FIG. 7 is a sixth schematic flowchart of a calibration method according to an embodiment of the disclosure;

FIG. 8 is a seventh schematic flowchart of a calibration method according to an embodiment of the disclosure;

FIG. 9 is a schematic diagram of a homonymy point according to an embodiment of the disclosure;

FIG. 10 is a schematic structural diagram of a calibration apparatus according to an embodiment of the disclosure;

FIG. 11 is a schematic diagram of a hardware structure of an electronic device according to an embodiment of the disclosure.

### DETAILED DESCRIPTION

In order that the solutions of the disclosure may be better understood by those skilled in the art, a clear and complete description of the technical solutions in the embodiments of the disclosure will be made below in combination with the drawings in the embodiments of the disclosure. It is be apparent that the described embodiments are merely a part of the embodiments of the disclosure, rather than all the embodiments. Based on the embodiments in the disclosure, all other embodiments obtained by those of ordinary skill in the art without paying any creative work fall within the protection scope of the disclosure.

The terms “first”, “second”, etc. in the description and claims as well as the drawings of the embodiments of the disclosure are used to distinguish different objects, rather than to describe a specific sequence. Furthermore, the terms “including” and “having” and any variations thereof are intended to cover non-exclusive inclusion. For example, a process, method, system, product or device including a series of steps or units is not limited to the listed steps or units, instead, optionally also includes steps or units which are not listed, or optionally also includes other steps or units inherent to such process, method, product or device.

Reference to “an embodiment” herein means that a specific feature, structure or characteristic described in combination with the embodiment may be included in at least one embodiment of the disclosure. The appearance of the phrase at various places in the description is not necessarily always referring to the same embodiment, nor to separate or alternative embodiments that are mutually exclusion with other embodiments. It will be understood by those skilled in the art explicitly and implicitly that the embodiments described herein may be combined with other embodiments.

In the embodiments, an inertial sensor may be used to measure physical quantities such as angular velocity, acceleration, etc. Since information, such as pose of an imaging device, etc., may be obtained based on images acquired by the imaging device, some specific functions may be realized by combining the inertial sensor with the imaging device. For example, an Inertial Measurement Unit (IMU) including an accelerometer and a gyroscope as well as the imaging device are loaded on a Unmanned Aerial Vehicle (UAV), and positioning of the UAV is realized by using acceleration information and angular velocity information acquired by the IMU as well as images acquired by the imaging device. For another example, an anti-shaking function of the imaging device is realized by using the angular velocity of the gyroscope acquired by the gyroscope mounted on the imaging device.

During combining the inertial sensor with the imaging device, data obtained by the inertial sensor and data obtained by the imaging device are processed by a processor. The processor processes the received data obtained by the inertial sensor and data obtained by the imaging device, so that the above specific functions may be realized.

On one hand, since the pose of the imaging device is different from the pose of the inertial sensor, that is, there is pose deviation between the imaging device and the inertial sensor, if the processor does not consider the pose deviation between the imaging device and the inertial sensor during processing the data obtained by the inertial sensor and the data obtained by the imaging device, or the processor obtains the pose deviation with low precision between the imaging device and the inertial sensor during processing the data obtained by the inertial sensor and the data obtained by the imaging device, then the effect of the realized specific function such as positioning, etc. is not good (for example, the precision of positioning is not high).

On the other hand, functions such as positioning, etc. may be realized by using the data obtained by the inertial sensor (such as angular velocity, acceleration) and the data obtained by the imaging device (such as the pose of the imaging device obtained by the acquired images) at the same time. For example, the UAV is loaded with a camera, an inertial sensor, and a Central Processing Unit (CPU), and the CPU acquires first data (e.g., images) of the imaging device and second data (e.g., angular velocity) of the inertial sensor at a time stamp a, so that the CPU may obtain the pose of the UAV at the time a from the first data and the second data.

That is, functions such as positioning, etc. realized based on the data obtained by the imaging device and the data obtained by the inertial sensor need the CPU to process the data of the inertial sensor and the data of the imaging device that are obtained at a same time stamp, to obtain the pose at the time stamp. However, if there is deviation (hereinafter referred to as time deviation) between the sampling time of the imaging device and the sampling time of the inertial sensor, then the time stamp of the data of the imaging device acquired by the CPU will be inaccurate, or the time stamp of the inertial sensor acquired by the CPU will be inaccurate. For example (Example 1), it is assumed that the data sampled by the imaging device at the time a is first data, the data sampled by the inertial sensor at the time a is second data, and the data sampled by the inertial sensor at the time b is third data. The imaging device transmits the first data to the CPU, and the inertial sensor transmits the second data and the third data to the CPU. However, since the speed at which the imaging device transmits the data is different from the speed at which the inertial sensor transmits the data, the CPU receives the second data at the time c and adds a time stamp c to the second data, and receives the first data and the third data at the time d and adds a time stamp d to both the first data and the third data, herein the time stamp b is different from the time stamp c.

It is apparent that inaccuracy of the time stamp will result in low accuracy of the functions such as positioning, etc. Next, continuing with Example 1, since the time stamp of the first data is the same as that of the third data, the CPU will process the first data and the third data to obtain the pose at the time d. Since the sampling time (i.e., the time a) of the first data is different from the sampling time (i.e., the time b) of the third data, the accuracy of the pose at the time d is low.

Based on the above two aspects, it is of great importance on how to determine at least one of the pose conversion relationship (i.e., the above pose deviation) or the sampling time offset between the imaging device and the inertial sensor. At least one of the pose conversion relationship or the sampling time offset may include the pose conversion relationship, and at least one of the pose conversion relationship or the sampling time offset may also include the sampling time offset, and at least one of the pose conversion relationship or the sampling time offset may also include the pose conversion relationship and the sampling time offset.

The calibration method provided based on the embodiment of the disclosure may determine the time-space deviation between the imaging device and the inertial sensor according to the images acquired by the imaging device and the data acquired by the inertial sensor.

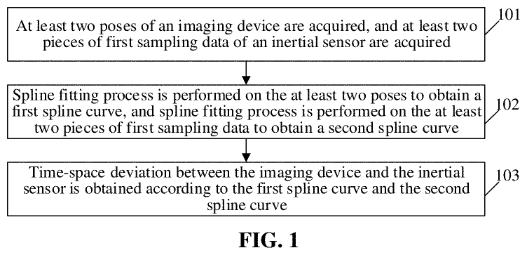

Referring to FIG. 1, which is a first schematic flowchart of a calibration method according to an embodiment of the disclosure, and as shown in FIG. 1, the method includes the following operations.

In operation 101, At least two poses of an imaging device are acquired, and at least two pieces of first sampling data of an inertial sensor are acquired.

An executive body in the embodiment of the disclosure is a first terminal, which may be one of a mobile phone, a computer, a tablet computer, a server, etc.

In the embodiment of the disclosure, the imaging device may include at least one of a camera or a webcam. The inertial sensor may include at least one of a gyroscope, an accelerometer, or an IMU.

In the embodiment of the disclosure, the pose may include at least one of a position or a posture. Herein the posture includes at least one of a pitch angle, a roll angle, or a yaw angle. For example, the at least two poses of the imaging device may be at least two positions of the imaging device, and/or the at least two poses of the imaging device may also be at least two postures of the imaging device.

In the embodiment of the disclosure, the first sampling data is the sampling data of the inertial sensor. For example, in a case that the inertial sensor is the gyroscope, the first sampling data includes an angular velocity. For another example, in a case that the inertial sensor is the accelerometer, the first sampling data includes acceleration.

A manner in which the first terminal acquires the at least two poses and acquires the at least two pieces of first sampling data may include receiving at least two poses and at least two pieces of first sampling data input by a user through an input component; herein the input component may include a keyboard, a mouse, a touch screen, a touch pad, an audio input device, etc. The manner may also include receiving at least two poses and at least two pieces of first sampling data transmitted by a second terminal; herein the second terminal includes a mobile phone, a computer, a tablet computer, a server, etc. The first terminal may establish a communication connection with the second terminal by means of wired connection or wireless communication, and receive the at least two poses and the at least two pieces of first sampling data transmitted by the second terminal.

In operation 102, spline fitting process is performed on the at least two poses to obtain a first spline curve, and spline fitting process is performed on the at least two pieces of first sampling data to obtain a second spline curve.

In the embodiment of the disclosure, each of the at least two poses carries a time stamp, and each of the at least two pieces of first sampling data carries time stamp information. For example, the time stamp characterized by the time stamp information of the first sampling data of the inertial sensor A is 14:46:30 on Dec. 6, 2019, and the first sampling data a is the angular velocity acquired by the inertial sensor A at 14:46:30 on Dec. 6, 2019.

Herein time stamps of any two of the at least two poses are different, and time stamps of any two of the at least two pieces of first sampling data are different.

In an embodiment, a pose sequence may be obtained by sorting the at least two poses in an ascending order of the time stamps. Since the pose sequence includes at least two discrete points, it is necessary to obtain a continuous function of the pose of the imaging device versus time, that is, to obtain the pose of the imaging device at any time, so as to facilitate subsequent processing.

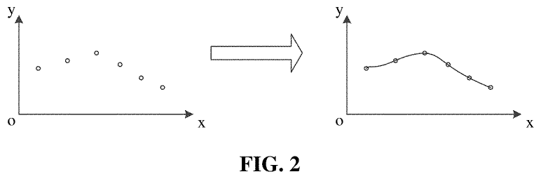

In a possible implementation, a function curve, i.e. a first spline curve, of the pose of the imaging device versus time may be obtained by performing spline fitting process on the pose sequence. FIG. 2 is a schematic diagram before and after performing spline fitting process on an angular velocity of an inertial sensor according to an embodiment of the disclosure; herein the left half of FIG. 2 is a schematic diagram before performing spline fitting process on the angular velocity of the inertial sensor, and the right half of FIG. 2 is a schematic diagram after performing spline fitting process on the angular velocity of the inertial sensor. As shown in the left half of FIG. 2, when a coordinate system xoy is established with the x-axis representing time and the y-axis representing the pose of the image device, a unique point may be determined in the coordinate system xoy according to the time stamp and the size of each pose. It may be seen from the left half of FIG. 2 that the pose sequence is a discrete point in the coordinate system xoy, that is, the pose of the imaging device during a time period between time stamps of any two poses is unknown. The spline curve as shown in the right half of FIG. 2, that is, the function curve of the pose of the imaging device versus time, may be obtained by performing the spline fitting process on the pose sequence.

Similarly, spline fitting process may be performed on the at least two pieces of first sampling data to obtain a continuous function curve of the sampling data of the inertial sensor versus time, i.e., a second spline curve.

In this possible implementation, the function curve of the pose of the imaging device versus time may be obtained by performing spline curve fitting process on the at least two poses, thereby obtaining the pose of the imaging device at any time. The function curve of the sampling data of the inertial sensor versus time may be obtained by performing spline curve fitting processing on the at least two pieces of first sampling data, thereby obtaining the sampling data of the inertial sensor at any time.

In an embodiment, the spline fitting process may be implemented by a spline fitting algorithm such as B-spline, Cubic Spline Interpolation, etc., which is not limited in the embodiment of the disclosure.

In operation 103, time-space deviation between the imaging device and the inertial sensor is obtained according to the first spline curve and the second spline curve.

In the embodiment of the disclosure, the time-space deviation may include a pose conversion relationship, the time-space deviation may also include a sampling time offset, and the time-space deviation may further include the pose conversion relationship and the sampling time offset.

In the embodiment of the disclosure, in a case that the pose includes a position, the first sampling data includes acceleration. In a case that the pose includes a posture, the first sampling data includes an angular velocity. That is, in a case that the first spline curve is a continuous function curve of the position of the imaging device versus time, the second spline curve is a continuous function curve of the acceleration of the inertial sensor versus time. In a case that the first spline curve is a continuous function curve of the posture of the imaging device versus time, the second spline curve is a continuous function curve of the angular velocity of the inertial sensor versus time.

In the case that the first spline curve is the continuous function curve of the position of the imaging device versus time, the first spline curve may be derived twice to obtain the continuous function curve (hereinafter, referred to as an acceleration spline curve) of the acceleration of the imaging device versus time. In the case that the first spline curve is the continuous function curve of the posture of the imaging device versus time, the first spline curve may be derived once to obtain the continuous function curve (hereinafter, referred to as an angular velocity spline curve) of the angular velocity of the imaging device versus time.

In a case that there is no pose deviation or sampling time deviation between the imaging device and the inertial sensor, and the first spline curve is the continuous function curve of the position of the imaging device versus time, the acceleration spline curve is the same as the second spline curve. Therefore, the time-space deviation between the imaging device and the inertial sensor may be determined from the acceleration spline curve and the second spline curve.

In a case that there is no pose deviation or sampling time deviation between the imaging device and the inertial sensor, and the first spline curve is the continuous function curve of the posture of the imaging device versus time, the angular velocity spline curve is the same as the second spline curve. Therefore, the time-space deviation between the imaging device and the inertial sensor may be determined from the angular velocity spline curve and the second spline curve.

In a possible implementation, it is first assumed that the pose deviation between the imaging device and the inertial sensor is a pose conversion relationship to be determined, and/or that the sampling time offset between the imaging device and the inertial sensor is a time offset to be determined. Then the acceleration spline curve is converted according to at least one of the pose conversion relationship to be determined or the time offset to be determined, to obtain the converted acceleration spline curve. In a case that the difference between the converted acceleration spline curve and the second spline curve is less than or equal to a first expected value, it means that the converted acceleration spline curve is the same as the second spline curve, so that the pose conversion relationship to be determined may be determined as the pose deviation between the imaging device and the inertial sensor, and/or the time offset to be determined may be determined as the sampling time offset between the imaging device and the inertial sensor.

In another possible implementation, it is first assumed that the pose deviation between the imaging device and the inertial sensor is a pose conversion relationship to be determined, and/or that the sampling time offset between the imaging device and the inertial sensor is a time offset to be determined. Then the angular velocity spline curve is converted according to at least one of the pose conversion relationship to be determined or the time offset to be determined, to obtain the converted angular velocity spline curve. In a case that the difference between the converted angular velocity spline curve and the second spline curve is less than or equal to a second expected value, it means that the converted angular velocity spline curve is the same as the second spline curve, so that the pose conversion relationship to be determined may be determined as the pose deviation between the imaging device and the inertial sensor, and/or the time offset to be determined may be determined as the sampling time offset between the imaging device and the inertial sensor.

In yet another possible implementation, it is first assumed that in a case that the difference between two curves is less than or equal to a third expected value, the two curves are determined to be the same. An added acceleration spline curve is obtained by adding the acceleration spline curve and the third expected value. A pose conversion relationship between the added acceleration spline curve and the second spline curve is obtained according to the added acceleration spline curve and the second spline curve, as the pose deviation between the imaging device and the inertial sensor, and/or a time deviation between the added acceleration spline curve and the second spline curve is obtained according to the added acceleration spline curve and the second spline curve, as the time offset between the imaging device and the inertial sensor.

In yet another possible implementation, it is first assumed that in a case that the difference between two curves is less than or equal to a fourth expected value, the two curves are determined to be the same. An added acceleration spline curve is obtained by adding the angular velocity spline curve and the fourth expected value. A conversion relationship between the added angular velocity spline curve and the second spline curve is obtained according to the added angular velocity spline curve and the second spline curve, as the pose deviation between the imaging device and the inertial sensor, and/or a time deviation between the added angular velocity spline curve and the second spline curve is obtained according to the added angular velocity spline curve and the second spline curve, as the time offset between the imaging device and the inertial sensor.

In the embodiment, spline fitting process is performed on the at least two poses of the imaging device to obtain the first spline curve, and spline fitting process is performed on the first sampling data of the inertial sensor to obtain the second spline curve. At least one of the pose conversion relationship or the sampling time offset deviation between the imaging device and the inertial sensor is determined according to the first spline curve and the second spline curve, so that the accuracy of at least one of the obtained pose conversion relationship or the sampling time offset between the imaging device and the inertial sensor may be improved.

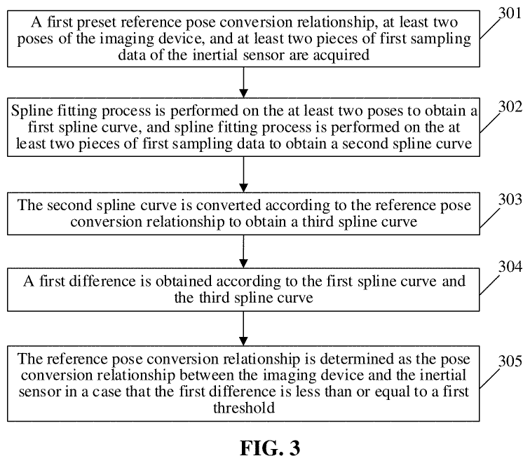

How to determine the sampling time offset between the imaging device and the inertial sensor will be explained in detail hereinafter. Referring to FIG. 3, which is a second schematic flowchart of a calibration method according to an embodiment of the disclosure, and as shown in FIG. 3, the method includes the following operations.

In operation 301, a preset reference pose conversion relationship, at least two poses of the imaging device, and at least two pieces of first sampling data of the inertial sensor are acquired.

In the embodiment of the disclosure, the preset reference pose conversion relationship includes a pose conversion matrix and an offset.

A manner in which the first terminal acquires the reference pose conversion relationship may include receiving the reference pose conversion relationship input by a user through an input component. Herein the input component may include any one of the components such as a keyboard, a mouse, a touch screen, a touch pad, an audio input device, etc. The manner in which the first terminal acquires the reference pose conversion relationship may also include receiving reference pose conversion relationship transmitted by a third terminal. Herein the third terminal includes any one of the devices such as a mobile phone, a computer, a tablet computer, a server, etc. The first terminal may receive the reference pose conversion relationship transmitted by the third terminal by means of wired connection or wireless connection.

In operation 302, spline fitting process is performed on the at least two poses to obtain a first spline curve, and spline fitting process is performed on the at least two pieces of first sampling data to obtain a second spline curve.

Reference may be made to the operation 102, and descriptions thereof will not be repeated herein.

In operation 303, the second spline curve is converted according to the reference pose conversion relationship to obtain a third spline curve.

In the embodiment of the disclosure, each pose carries time stamp information. The at least two poses are poses of the imaging device at different times, that is, time stamps of any two of the at least two poses are different. For example, in a case that the pose includes a posture, at least two postures of the imaging device A include postures B and C, herein the posture B includes a pitch angle a, a roll angle b and a yaw angle c, and the time stamp of the posture B is a time stamp D; the pose C includes a pitch angle d, a roll angle e and a yaw angle f, and the time stamp of the posture C is a time stamp E. It may be seen from the postures B and C that the pitch angle, the roll angle and the yaw angle of the imaging device A at the time stamp D are a, b and c respectively, and the pitch angle, the roll angle and the yaw angle of the imaging device A at the time stamp E are d, e and f respectively.

Due to the pose deviation between the imaging device and the inertial sensor, there is a deviation between the pose obtained based on the imaging device and the pose obtained based on the inertial sensor. If a real pose conversion relationship between the imaging device and the inertial sensor may be determined, the pose obtained by the imaging device or the pose obtained by the inertial sensor may be converted based on the real pose conversion relationship, so as to reduce the pose deviation between the imaging device and the inertial sensor. For example, it is assumed that the pose deviation between the imaging device and the inertial sensor is C, if the pose conversion relationship corresponding to the pose deviation C is D, the pose obtained based on the imaging device is A, and the pose obtained based on the inertial sensor is B, then the pose deviation between the poses A and B is C. The pose A is multiplied by the pose conversion relationship D to obtain the pose E (that is, the posture A is converted based on the pose conversion relationship), then the pose E is the same as the pose B; or the pose B is multiplied by the pose conversion relationship D to obtain the pose F (that is, the posture B is converted based on the pose conversion relationship), then the pose F is the same as the pose A.

In other words, in a case that the positional deviation between the imaging device and the inertial sensor is not determined, it is impossible to obtain the real pose conversion relationship between the imaging device and the inertial sensor. By assuming the conversion relationship between the imaging device and the inertial sensor (i.e., the above reference pose conversion relationship), the deviation between the reference pose conversion relationship and the real pose conversion relationship may be determined according to an error between the pose obtained by the imaging device and the pose obtained based on the inertial sensor. In a possible implementation, the second spline curve is multiplied by the reference pose conversion relationship to obtain the third spline curve.

In operation 304, a first difference is obtained according to the first spline curve and the third spline curve.

In one possible implementation, the difference between the points with the same time stamp of the first spline curve and the third spline curve is used as the first difference. For example, the first spline curve contains points a and b, and the third spline curve contains points c and d. The time stamps of the points a and c are A, and the time stamps of the points b and d are B. The difference between the points a and c may be used as the first difference. The difference between the points b and d may also be used as the first difference. The average value of the difference between the points a and c as well as the difference between the points b and d may also be used as the first difference.

In another possible implementation, the difference between the points with the same time stamp of the first spline curve and the third spline curve is determined to obtain the first difference; the sum of the first difference and the first reference value is used as the first difference, herein the first reference value is a real number, and in an embodiment, the first reference value may be 0.0001 m. For example, the first spline curve contains points a and b, and the third spline curve contains points c and d. The time stamps of the points a and c are A, and the time stamps of the points b and d are B. The difference between the points a and c is C, and the difference between the points b and d is D. It is assumed that the first reference value is E. C+E may be used as the first difference. D+E may also be used as the first difference. (C+E+D+E)/2 may also be used as the first difference.

In yet another possible implementation, the difference between the points with the same time stamp of the first spline curve and the third spline curve is determined to obtain a second difference. The square of the second difference is used as the first difference. For example, the first spline curve contains points a and b, and the third spline curve contains points c and d. The time stamps of the points a and c are A, and the time stamps of the points b and d are B. The difference between the points a and c is C, and the difference between the points b and d is D. C² may be used as the first difference, D² may also be used as the first difference, and (C²+D²)/2 may also be used as the first difference.

In operation 305, the reference pose conversion relationship is determined as the pose conversion relationship between the imaging device and the inertial sensor in a case that the first difference is less than or equal to a first threshold.

Since the difference between the third spline curve and the first spline curve (i.e., the first difference) may be used to characterize the deviation between the reference pose conversion relationship and the real pose conversion relationship, the first difference less than or equal to the expected value (i.e., the first threshold) may be used as a constraint for solving the reference pose conversion relationship. Exemplarily, the unit of the first threshold is meter, and the value range of the first threshold is a positive number. In an embodiment, the value of the first threshold may be 1 mm.

For example, it is assumed that the first spline curve satisfies y=f(x), herein f(x) is a function of the angular velocity of the gyroscope versus time, y is the angular velocity of the gyroscope, and x is time; the second spline curve satisfies u=v(x), where v(x) is a function curve of the angular velocity of the gyroscope versus time, u is the angular velocity of the gyroscope, and x is time; the reference pose conversion relationship is Q, the third spline curve satisfies s=v(x)×Q=r(x), herein r(x) is a function curve of the angular velocity of the imaging device versus time, s is the angular velocity of the imaging device, and x is time. If the first threshold is 1 mm, then |r(x)−f(x)|≤1 mm, that is, |v(x)□Q−f(x)|≤1 mm (this expression is denoted as Equation (1)). Since f(x) and v(x) are known in Equation (1), the reference pose conversion relationship Q may be determined by solving the inequality.

In an embodiment, the Equation (1) may be solved by any one of the levenberg-marquardt algorithm and the gauss-newton iteration method.

In the embodiment, the first spline curve is obtained by performing spline fitting process on the pose of the imaging device, and the second spline curve is obtained by performing spline fitting process on the first sampling data of the inertial sensor. The first spline curve is converted based on the reference pose conversion relationship to obtain the third spline curve. Since both the first spline curve and the third spline curve are continuous function curves, it is determined whether the reference pose conversion relationship is the pose conversion relationship between the imaging device and the inertial sensor according to the difference between the first spline curve and the third spline curve, so that the accuracy of the obtained pose conversion relationship between the imaging device and the inertial sensor may be improved.

Based on the above embodiment, an embodiment of the disclosure further provides a method of determining the time deviation between the inertial sensor and the imaging device.

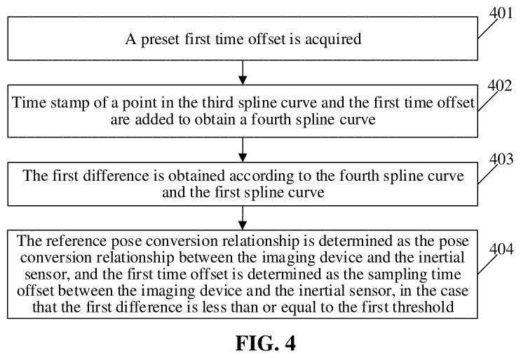

FIG. 4 is a third schematic flowchart of a calibration method according to an embodiment of the disclosure. As shown in FIG. 4, the method may include the following operations.

In operation 401, a preset first time offset is acquired.

The idea for determining the time deviation between the imaging device and the inertial sensor in the embodiment of the disclosure is the same as the idea for determining the pose conversion relationship between the imaging device and the inertial sensor in the above embodiment. That is, if there is no time deviation between the imaging device and the inertial sensor, the deviation between the angular velocity of the imaging device and the angular velocity of the inertial sensor at the same time is small.

Based on this idea, in the embodiment, it is first assumed that the time deviation between the imaging device and the inertial sensor is a first time offset. In the subsequent processing, the function curve of the angular velocity of the inertial sensor versus time is obtained by adding the function curve of the pose of the imaging device versus time and the first time offset.

In an alternative implementation, a manner in which the first terminal acquires the first time offset may include receiving, by the first terminal, the first time offset input by a user through an input component; herein the input component may include any one of the components a keyboard, a mouse, a touch screen, a touch pad, an audio input device, etc. In another alternative implementation, the manner in which the first terminal acquires the first time offset may also include receiving, by the first terminal, the first time offset transmitted by a third terminal. Herein the third terminal includes any one of the devices such as a mobile phone, a computer, a tablet computer, a server, etc. The third terminal and the second terminal may be the same terminal or different terminals.

In operation 402, time stamp of a point in the third spline curve and the first time offset are added to obtain a fourth spline curve.

In operation 403, the first difference is obtained according to the fourth spline curve and the first spline curve.

In contrast to the implementation of the above embodiment in which the first difference is obtained according to the first spline curve and the third spline curve, the first difference is obtained from the first spline curve and the fourth spline curve in the embodiment.

In a possible implementation, the difference between the points with the same time stamp of the fourth spline curve and the first spline curve is used as the first difference. For example, the fourth spline curve contains points a and b, and the first spline curve contains points c and d. The time stamps of the points a and c are A, and the time stamps of the points b and d are B. The difference between the points a and c may be used as the first difference. The difference between the points b and d may also be used as the first difference. The average value of the difference between the points a and c as well as the difference between the points b and d may also be used as the first difference.

In another possible implementation, the difference between the points with the same time stamp of the fourth spline curve and the first spline curve is determined to obtain the third difference; the sum of the third difference and the second reference value is used as the first difference, herein the second reference value is a real number, and in an embodiment, the second reference value may be 0.0001 m. For example, the fourth spline curve contains points a and b, and the first spline curve contains points c and d. The time stamps of the points a and c are A, and the time stamps of the points b and d are B. The difference between the points a and c is C, and the difference between the points b and d is D. It is assumed that the second reference value is E. C+E may be used as the first difference. D+E may also be used as the first difference. (C+E+D+E)/2 may also be used as the first difference.

In yet another possible implementation, the difference between the points with the same time stamp of the fourth spline curve and the first spline curve is determined to obtain a fourth difference. The square of the fourth difference is used as the first difference. For example, the fourth spline curve contains points a and b, and the first spline curve contains points c and d. The time stamps of the points a and c are A, and the time stamps of the points b and d are B. The difference between the points a and c is C, and the difference between the points b and d is D. C² may be used as the first difference, D² may also be used as the first difference, and (C²+D²)/2 may also be used as the first difference.

In operation 404, the reference pose conversion relationship is determined as the pose conversion relationship between the imaging device and the inertial sensor, and the first time offset is determined as the sampling time offset between the imaging device and the inertial sensor, in the case that the first difference is less than or equal to the first threshold.

Since the first time offset is the imaginary time deviation between the imaging device and the inertial sensor, the shape of the fourth spline curve obtained in the operation 202 should be the same as that of the third spline curve. However, in practical applications, there may be an error between the fourth spline curve and the third spline curve. Therefore, in the embodiment of the disclosure, a case where the difference between the fourth spline curve and the third spline curve is less than or equal to the first threshold is considered as the fourth spline curve being the same as the third spline curve. In a case that the fourth spline curve is the same as the third spline curve, the first time offset may be determined as the time deviation between the imaging device and the inertial sensor, and then it may be known in combination with the above embodiment that the reference pose conversion relationship is the pose conversion relationship between the imaging device and the inertial sensor.

In the embodiment, the time stamp of the point in the third spline curve and the first time offset are added to obtain the fourth spline curve, then it is determined whether the first time offset is the time deviation between the imaging device and a gyroscope, and whether the reference pose conversion relationship is the pose conversion relationship between the imaging device and the gyroscope according to the difference between the fourth spline curve and the first spline curve, so that the accuracy of the obtained pose conversion relationship and the time deviation between the imaging device and the inertial sensor may be improved.

It should be understood that the technical solution provided by the embodiment is realized based on the foregoing embodiment. In actual processing, the sampling time deviation between the imaging device and the inertial sensor may also be determined without the determination of the pose conversion relationship between the imaging device and the inertial sensor.

In a possible implementation, the time-space deviation includes the sampling time offset; the calibration method may further include the following operations. A preset second time offset, at least two poses of the imaging device, and at least two pieces of first sampling data of the inertial sensor are acquired; spline fitting processing is performed on the at least two poses to obtain a first spline curve, and spline fitting processing is performed on the at least two pieces of first sampling data to obtain a second spline curve; time stamp of a point in the first spline curve and the second time offset are added to obtain a ninth spline curve; and a fourth difference is obtained according to the ninth spline curve and the second spline curve. In the case that the fourth difference is less than or equal to the fourth threshold, the second time offset is determined as the sampling time offset between the imaging device and the inertial sensor.

The detailed description of the embodiment is similar to the combination of the embodiments shown in FIGS. 3 and 4, and reference may be made to the foregoing descriptions of the embodiments for the details, and descriptions thereof will not be repeated herein.

In a case that the inertial sensor is IMU, an embodiment of the disclosure further provides a method for calibrating an imaging device and IMU.

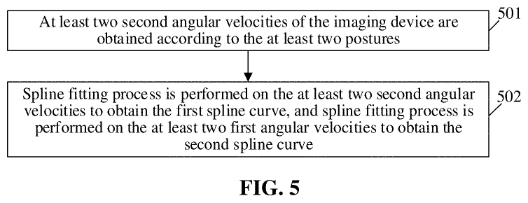

FIG. 5 is a fourth schematic flowchart of a calibration method according to an embodiment of the disclosure; the embodiment provides a specific description of one possible implementation of the operation 102. As shown in FIG. 5, the method may include the following operations.

In operation 501, at least two second angular velocities of the imaging device are obtained according to the at least two postures.

In the embodiment, the at least two poses may include at least two postures, and the at least two pieces of first sampling data may include at least two first angular velocities. Herein the at least two first angular velocities are sampled by gyroscope in the IMU.

In some alternative embodiments, the at least two second angular velocities of the imaging device may be obtained by deriving at least two postures of the imaging device.

In operation 502, spline fitting process is performed on the at least two second angular velocities to obtain the first spline curve, and spline fitting process is performed on the at least two first angular velocities to obtain the second spline curve.

The implementation of the operation may refer to the operation 102, herein the at least two second angular velocities correspond to at least two poses in the operation 102, and the at least two first angular velocities correspond to at least two pieces of first sampling data in the operation 102.

Based on the technical solution provided in the embodiment, a function curve (i.e., the first spline curve) of the angular velocity of the imaging device versus time is obtained based on at least two postures of the imaging device, and a function curve (i.e., the second spline curve) of the angular velocity of the IMU versus time is obtained based on the gyroscope in the IMU. At least one of the pose conversion relationship or the sampling time offset between the imaging device and the IMU may be determined based on the first spline curve and the second spline curve, for example, at least one of the pose conversion relationship or the sampling time offset between the imaging device and the IMU may be determined by using the technical solution provided in the foregoing embodiment.

Since the IMU includes the accelerometer in addition to the gyroscope, the accuracy of at least one of the obtained pose conversion relationship or the sampling time offset between the imaging device and the IMU may be improved by using the data sampled by the accelerometer in the IMU based on the embodiment.

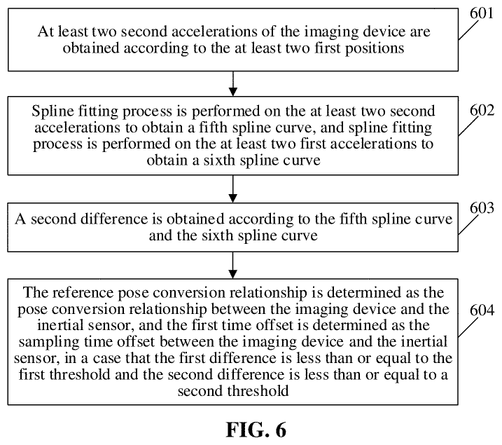

FIG. 6 is a fifth schematic flowchart of a calibration method according to an embodiment of the disclosure. In the embodiment, the at least two poses further include at least two first positions, and the at least two pieces of first sampling data further include at least two first accelerations. Herein the at least two first accelerations are sampled by the accelerometer in the IMU. As shown in FIG. 6, the method may include the following operations.

In operation 601, at least two second accelerations of the imaging device are obtained according to the at least two first positions.

In operation 602, spline fitting process is performed on the at least two second accelerations to obtain a fifth spline curve, and spline fitting process is performed on the at least two first accelerations to obtain a sixth spline curve.

The implementation of the operation may refer to the operation 102, herein the at least two second accelerations correspond to at least two poses in the operation 102, and the fifth spline curve corresponds to the first spline curve in the operation 102; the at least two first accelerations correspond to at least two pieces of first sampling data in the operation 102, and the sixth spline curve corresponds to the second spline curve in the operation 102.

In operation 603, a second difference is obtained according to the fifth spline curve and the sixth spline curve.

The operation may refer to the operation 403, herein the fifth spline curve corresponds to the first spline curve in the operation 403, the sixth spline curve corresponds to the fourth spline curve in the operation 403, and the second difference corresponds to the first difference in the operation 403.

In operation 604, the reference pose conversion relationship is determined as the pose conversion relationship between the imaging device and the inertial sensor, and the first time offset is determined as the sampling time offset between the imaging device and the inertial sensor, in a case that the first difference is less than or equal to the first threshold and the second difference is less than or equal to a second threshold.

If there is no at least one of the pose deviation or sampling time offset between the imaging device and the IMU, then the difference between the angular velocity of the imaging device and the angular velocity of the IMU should be small, and the difference between the acceleration of the imaging device and the acceleration of the IMU should also be small. Therefore, in the embodiment, the reference pose conversion relationship is determined as the pose conversion relationship between the imaging device and the inertial measurement unit, and the first time offset is determined as the sampling time offset between the imaging device and the inertial sensor, in the case that the first difference is less than or equal to the first threshold and the second difference is less than or equal to the second threshold.

In the embodiment, the second difference is obtained by using the data sampled by the accelerometer of the IMU and the first position of the imaging device based on the foregoing embodiment. Then it is determined whether the reference pose conversion relationship is the pose conversion relationship between the imaging device and the IMU, and whether the first time offset is the sampling time offset between the imaging device and the IMU according to the first difference and the second difference, so that the accuracy of the obtained pose conversion relationship and the time deviation between the imaging device and the inertial sensor may be improved.

Furthermore, calibration of the imaging device and the IMU may also be realized based on the data acquired by the accelerometer in the IMU and the position of the imaging device.

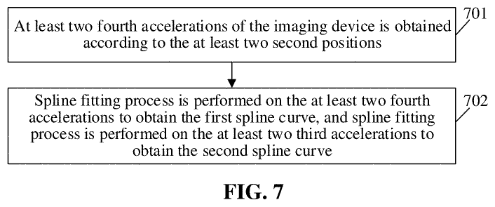

FIG. 7 is a sixth schematic flowchart of a calibration method according to an embodiment of the disclosure; the embodiment provides a specific description of another possible implementation of the operation 102. In the embodiment, the at least two poses include at least two second positions, and the at least two pieces of first sampling data include at least two third accelerations. Herein the at least two third accelerations are sampled by the accelerometer in the IMU. As shown in FIG. 7, the method may include the following operations.

In operation 701, at least two fourth accelerations of the imaging device is obtained according to the at least two second positions.

In the embodiment, the at least two fourth accelerations of the imaging device may be obtained by deriving the at least two second positions of the imaging device twice.

In operation 702, spline fitting process is performed on the at least two fourth accelerations to obtain the first spline curve, and spline fitting process is performed on the at least two third accelerations to obtain the second spline curve.

The implementation of the operation may refer to the operation 102, herein the at least two fourth accelerations correspond to at least two poses in the operation 102, and the at least two third accelerations correspond to at least two pieces of first sampling data in the operation 102.

Based on the technical solution provided in the embodiment, a function curve (i.e., the first spline curve) of the acceleration of the imaging device versus time is obtained based on at least two second positions of the imaging device, and a function curve (i.e., the second spline curve) of the acceleration of the IMU versus time is obtained based on the accelerometer in the IMU. At least one of the pose conversion relationship or the sampling time offset between the imaging device and the IMU may be determined based on the first spline curve and the second spline curve, for example, at least one of the pose conversion relationship or the sampling time offset between the imaging device and the IMU may be determined by using the technical solution provided in the foregoing embodiment.

Since the IMU includes the gyroscope in addition to the accelerometer, the accuracy of at least one of the obtained pose conversion relationship or the sampling time offset between the imaging device and the IMU may be improved by using the data sampled by the gyroscope in the IMU based on the embodiment.

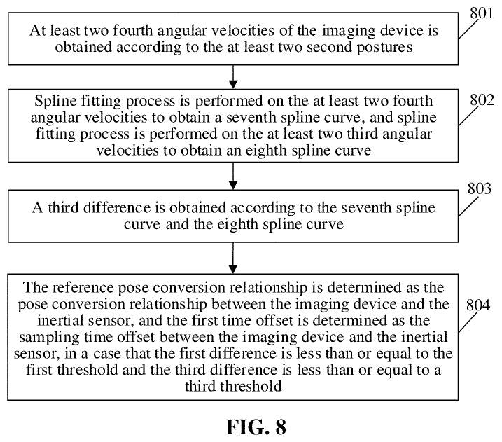

FIG. 8 is a seventh schematic flowchart of a calibration method according to an embodiment of the disclosure. In the embodiment, the at least two poses further include at least two second postures, and the at least two pieces of first sampling data further include at least two third angular velocities. Herein the at least two third angular velocities are sampled by the gyroscope in the IMU. As shown in FIG. 8, the method may include the following operations.

In operation 801, at least two fourth angular velocities of the imaging device is obtained according to the at least two second postures.

In operation 802, spline fitting process is performed on the at least two fourth angular velocities to obtain a seventh spline curve, and spline fitting process is performed on the at least two third angular velocities to obtain an eighth spline curve.

The implementation of the operation may refer to the operation 102, herein the at least two fourth angular velocities correspond to at least two poses in the operation 102, and the seventh spline curve corresponds to the first spline curve in the operation 102; and the at least two third angular velocities correspond to at least two pieces of first sampling data in the operation 102, and the eighth spline curve corresponds to the second spline curve in the operation 102.

In operation 803, a third difference is obtained according to the seventh spline curve and the eighth spline curve.

The operation may refer to the operation 403, herein the seventh spline curve corresponds to the first spline curve in the operation 403, the eighth spline curve corresponds to the fourth spline curve in the operation 403, and the third difference corresponds to the first difference in the operation 403.

In operation 804, the reference pose conversion relationship is determined as the pose conversion relationship between the imaging device and the inertial sensor, and the first time offset is determined as the sampling time offset between the imaging device and the inertial sensor, in a case that the first difference is less than or equal to the first threshold and the third difference is less than or equal to a third threshold.

If there is no at least one of the pose deviation or sampling time offset between the imaging device and the IMU, then the difference between the angular velocity of the imaging device and the angular velocity of the IMU should be small, and the difference between the acceleration of the imaging device and the acceleration of the IMU should also be small. Therefore, in the embodiment, the reference pose conversion relationship is determined as the pose conversion relationship between the imaging device and the inertial measurement unit, and the first time offset is determined as the sampling time offset between the imaging device and the inertial sensor, in the case that the first difference is less than or equal to the first threshold and the third difference is less than or equal to the third threshold.

In the embodiment, the third difference is obtained by using the data sampled by the gyroscope of the IMU and the second posture of the imaging device based on the foregoing embodiment. Then it is determined whether the reference pose conversion relationship is the pose conversion relationship between the imaging device and the IMU, and whether the first time offset is the sampling time offset between the imaging device and the IMU according to the first difference and the third difference, so that the accuracy of the obtained pose conversion relationship and the time deviation between the imaging device and the inertial sensor may be improved.

Based on the technical solutions provided in the embodiments of the disclosure, the embodiments of the disclosure further provide several application scenarios:

Scenario A: the imaging device and the IMU belong to an electronic device, and positioning of the electronic device may be achieved based on the imaging device and the IMU. The implementation thereof is as follows:

At least two images are acquired by using the imaging device, and at least two pieces of second sampling data acquired by the IMU are acquired during acquisition of the at least two images by the imaging device. Herein the number of the images acquired by the imaging device is equal to or greater than 1 and the second sampling data includes at least one of angular velocity or acceleration. For example, the electronic device acquires at least two images by using the imaging device during a reference time period, and the electronic device acquires at least two pieces of second sampling data including at least one of angular velocity or acceleration by using the IMU for acquisition during the reference time period.

The homonymy points in the at least two images may be determined by performing feature point matching process on the at least two images. A movement trajectory of the homonymy points in the image coordinate system, that is, a movement trajectory of the electronic device in the image coordinate system (hereinafter referred to as a first movement trajectory) may be obtained based on the coordinates of the homonymy points in at least two images. A movement trajectory of the electronic device in the world coordinate system (hereinafter referred to as a second movement trajectory) may be obtained based on the at least two pieces of second sampling data.

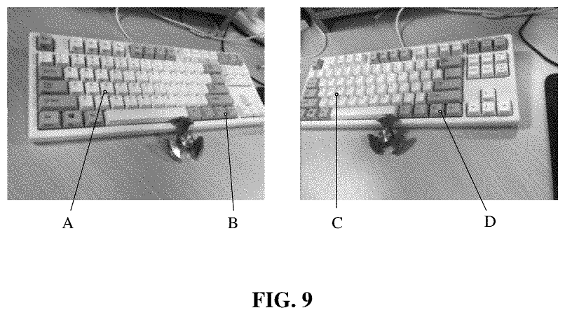

In the embodiment of the disclosure, the pixel points of the same physical point in two different images are homonymy points with respect to each other. FIG. 9 shows two images, herein pixel point A and pixel point C are homonymy points with respect to each other, and pixel point B and pixel point D are homonymy points with respect to each other.

The imaging device and the IMU in the electronic device are calibrated based on the technical solutions provided in the embodiments of the disclosure, the pose conversion relationship between the imaging device and the IMU is determined as the first pose conversion relationship, and the sampling time offset between the imaging device and the IMU is determined as the first sampling time offset.

The time stamp of the first movement trajectory and the first sampling time offset are added to obtain a third movement trajectory. The third movement trajectory is converted according to the first pose conversion relationship to obtain a fourth movement trajectory. The pose conversion relationship between the second movement trajectory and the fourth movement trajectory, that is, the pose conversion relationship between the movement trajectory of the electronic device in the image coordinate system and the movement trajectory of the electronic device in the world coordinate system (hereinafter referred to as a second pose conversion relationship) is obtained according to the second movement trajectory and the fourth movement trajectory.

A fifth movement trajectory, that is, the movement trajectory of the electronic device in the world coordinate system, is obtained from the second pose conversion relationship and the first movement trajectory.

Each of the acquired at least two images contains a time stamp, the minimum of the time stamps of the at least two images is used as a reference time stamp. The pose of the electronic device at the reference time stamp (hereinafter, referred to as the initial pose) is acquired.

The pose of the electronic device at any time within the target time period may be determined based on the initial pose and the fifth movement trajectory, herein the target time period is a time period in which at least two images are acquired.

Scenario B: Augmented Reality (AR) technology is a technology that intelligently fuses virtual information with the real world, and the technology may superimpose the virtual information and the real environment into a picture in real time. An intelligent terminal may implement the AR technology based on an IMU and a camera, herein the intelligent terminal includes a mobile phone, a computer and a tablet computer. For example, the mobile phone may implement the AR technology based on an IMU and a camera.

To improve the effect of the AR technology implemented by the intelligent terminal, the IMU and the camera of the intelligent terminal may be calibrated by using the technical solutions provided in the embodiments of the disclosure.

In a possible implementation of calibrating the IMU and the camera of the intelligent terminal, at least six images and at least six IMU data (including angular velocity and acceleration) are obtained by photographing a calibration plate by a mobile intelligent terminal. Based on the technical solutions provided in the embodiments of the disclosure, the pose conversion relationship between the camera of the intelligent terminal and the IMU of the intelligent terminal may be obtained by using the at least six images and the at least six IMU data. Based on the technical solutions provided in the embodiments of the disclosure, the pose conversion relationship and the time deviation between the camera of the intelligent terminal and the IMU of the intelligent terminal may be obtained by using the at least six images and the at least six IMU data.

It will be appreciated by those skilled in the art that in the above methods of the detailed description, the order in which the operations are written does not imply a strict execution order thereby constituting any limitation on the implementation, and the specific execution order of the operations should be determined based on their functions and possible intrinsic logic.

The method according to embodiments of the disclosure is described in detail as above, and the apparatus according to embodiments of the disclosure is provided below.

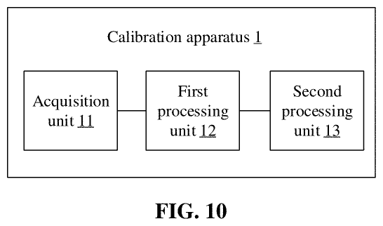

Referring to FIG. 10, which is a schematic structural diagram of a calibration apparatus according to an embodiment of the disclosure. The calibration apparatus 1 includes an acquisition unit 11, a first processing unit 12 and a second processing unit 13.

The acquisition unit 11 is configured to acquire at least two poses of an imaging device, and acquire at least two pieces of first sampling data of an inertial sensor.

The first processing unit 12 is configured to perform spline fitting process on the at least two poses to obtain a first spline curve, and perform spline fitting process on the at least two pieces of first sampling data to obtain a second spline curve.

The second processing unit 13 is configured to obtain time-space deviation between the imaging device and the inertial sensor according to the first spline curve and the second spline curve, the time-space deviation includes at least one of a pose conversion relationship or a sampling time offset.

In combination with any one of the embodiments of the disclosure, the time-space deviation includes the pose conversion relationship;

the acquisition unit 11 is further configured to acquire a preset reference pose conversion relationship before the second processing unit 13 obtains the time-space deviation between the imaging device and the inertial sensor according to the first spline curve and the second spline curve;

the first processing unit 12 is further configured to convert the second spline curve according to the reference pose conversion relationship to obtain a third spline curve;

the second processing unit 13 is configured to: obtain a first difference according to the first spline curve and the third spline curve; and determine the reference pose conversion relationship as the pose conversion relationship between the imaging device and the inertial sensor in a case that the first difference is less than or equal to a first threshold.

In combination with any one of the embodiments of the disclosure, the time-space deviation further includes the sampling time offset; each point in the first spline curve carries time stamp information;

the acquisition unit 11 is further configured to acquire a preset first time offset before determining the reference pose conversion relationship as the pose conversion relationship between the imaging device and the inertial sensor, in the case that the first difference is less than or equal to the first threshold;

the first processing unit 12 is configured to add time stamp of a point in the third spline curve and the first time offset to obtain a fourth spline curve;

the second processing unit 13 is configured to: obtain the first difference according to the fourth spline curve and the first spline curve; and determine the reference pose conversion relationship as the pose conversion relationship between the imaging device and the inertial sensor and determine the first time offset as the sampling time offset between the imaging device and the inertial sensor, in the case that the first difference is less than or equal to the first threshold.

In combination with any one of the embodiments of the disclosure, the inertial sensor includes an inertial measurement unit; the at least two poses include at least two postures; the at least two pieces of first sampling data include at least two first angular velocities;

the first processing unit 12 is configured to: obtain at least two second angular velocities of the imaging device according to the at least two postures; perform spline fitting process on the at least two second angular velocities to obtain the first spline curve; and perform spline fitting process on the at least two first angular velocities to obtain the second spline curve.

In combination with any one of the embodiments of the disclosure, the at least two poses further include at least two first positions; the at least two pieces of first sampling data further include at least two first accelerations;

the first processing unit 12 is configured to, before the reference pose conversion relationship is determined as the pose conversion relationship between the imaging device and the inertial sensor and the first time offset is determined as the sampling time offset between the imaging device and the inertial sensor in the case that the first difference is less than or equal to the first threshold, obtain at least two second accelerations of the imaging device according to the at least two first positions, perform spline fitting process on the at least two second accelerations to obtain a fifth spline curve, and perform spline fitting process on the at least two first accelerations to obtain a sixth spline curve;

the second processing unit 13 is configured to: obtain a second difference according to the fifth spline curve and the sixth spline curve; and determine the reference pose conversion relationship as the pose conversion relationship between the imaging device and the inertial sensor and determine the first time offset as the sampling time offset between the imaging device and the inertial sensor, in a case that the first difference is less than or equal to the first threshold and the second difference is less than or equal to a second threshold.

In combination with any one of the embodiments of the disclosure, the inertial sensor includes an inertial measurement unit; the at least two poses include at least two second positions; the at least two pieces of first sampling data include at least two third accelerations;

the first processing unit 12 is configured to: obtain at least two fourth accelerations of the imaging device according to the at least two second positions; perform spline fitting process on the at least two fourth accelerations to obtain the first spline curve; and perform spline fitting process on the at least two third accelerations to obtain the second spline curve.

In combination with any one of the embodiments of the disclosure, the at least two poses further include at least two second postures; the at least two pieces of first sampling data further include at least two third angular velocities;

the first processing unit 12 is configured to obtain at least two fourth angular velocities of the imaging device according to the at least two second postures, before the reference pose conversion relationship is determined as the pose conversion relationship between the imaging device and the inertial sensor and the first time offset is determined as the sampling time offset between the imaging device and the inertial sensor in the case that the first difference is less than or equal to the first threshold;

the second processing unit 13 is configured to: perform spline fitting process on the at least two fourth angular velocities to obtain a seventh spline curve, and perform spline fitting process on the at least two third angular velocities to obtain an eighth spline curve; obtain a third difference according to the seventh spline curve and the eighth spline curve; and determine the reference pose conversion relationship as the pose conversion relationship between the imaging device and the inertial sensor and determine the first time offset as the sampling time offset between the imaging device and the inertial sensor, in a case that the first difference is less than or equal to the first threshold and the third difference is less than or equal to a third threshold.

In combination with any one of the embodiments of the disclosure, the time-space deviation includes the sampling time offset;

the acquisition unit 11 is further configured to acquire a preset second time offset before obtaining the time-space deviation between the imaging device and the inertial sensor according to the first spline curve and the second spline curve;

the first processing unit 12 is further configured to add time stamp of a point in the first spline curve and the second time offset to obtain a ninth spline curve;

the second processing unit 13 is configured to: obtain a fourth difference according to the ninth spline curve and the second spline curve; and determine the second time offset as the sampling time offset between the imaging device and the inertial sensor in a case that the fourth difference is less than or equal to a fourth threshold.

In combination with any one of the embodiments of the disclosure, the imaging device and the inertial sensor belong to the calibration apparatus 1;

the imaging device is configured to acquire at least two images;

the inertial sensor is configured to obtain at least two pieces of second sampling data during acquisition of the at least two images by the imaging device;

the acquisition unit 11 is configured to obtain a pose of the imaging device when the images are acquired, according to the at least two images, the at least two pieces of second sampling data and the time-space deviation.

In the embodiment, spline fitting process is performed on the at least two poses of the imaging device to obtain the first spline curve, and spline fitting process is performed on the first sampling data of the inertial sensor to obtain the second spline curve, and at least one of the pose conversion relationship or the sampling time offset deviation between the imaging device and the inertial sensor is determined according to the first spline curve and the second spline curve, so that the accuracy of at least one of the obtained pose conversion relationship or the sampling time offset between the imaging device and the inertial sensor may be improved.

In some embodiments, the apparatus provided in the embodiments of the disclosure may have functions for performing the methods described in the above method embodiments or include modules for performing the methods described in the above method embodiments, and specific implementations thereof may refer to the descriptions of the above method embodiments, and descriptions thereof will not be repeated herein for brevity.

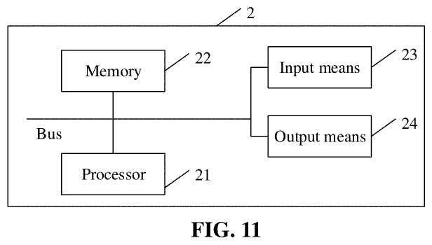

FIG. 11 is a schematic diagram of a hardware structure of an electronic device according to an embodiment of the disclosure. As shown in FIG. 11, the electronic device 2 includes a processor 21 and a memory 22 configured to store a computer program code including computer instructions that, when executed by the processor 21, cause the electronic device to perform the calibration method according to any one of the above embodiments of the disclosure.

In an embodiment, the electronic device 2 may further include an input means 23 and an output means 24. Each component in the electronic device 2 may be coupled by a connector including various interfaces, transmission lines, buses, etc., which is not limited in the embodiment of the disclosure. It should be understood that in the embodiments of the disclosure, coupling refers to interconnection by specific means, including direct connection or indirect connection by other equipment, such as connection by various interfaces, transmission lines, buses, etc.

The processor 21 may include one or more processors, such as one or more CPUs. When the processor is a CPU, the CPU may be a single-core CPU or a multi-core CPU. In an embodiment, the processor 21 may be a processor group composed of multiple Graphic Processing Units (GPUs), multiple processors are coupled to each other by one or more buses. In an embodiment, the processor may also be other types of processors, etc., which is not limited in the embodiment of the disclosure.

The memory 22 may be configured to store computer program instructions, as well as various types of computer program codes including program codes for executing the solutions of the disclosure. In an embodiment, the memory includes, but is not limited to, Random Access Memory (RAM), Read-Only Memory (ROM), Erasable Programmable Read Only Memory (EPROM), or Compact Disc Read-Only Memory (CD-ROM) for related instructions and data.

The input means 23 is configured to input at least one of data or signals, and the output means 24 is configured to output at least one of data or signals. The input means 23 and the output means 24 may be separate devices or may be an integral device.

It will be appreciated that in the embodiments of the disclosure, the memory 22 may be configured to not only store related instructions, but also store related data, for example, the memory 22 may be configured to store the first sampling data obtained by the input means 23, or the memory 22 may be configured to store the time-space deviation obtained by the processor 21, etc., and the embodiment of the disclosure does not limit the specific data stored in the memory.

It will be appreciated that FIG. 11 only shows a simplified design of an electronic device. In practical applications, the electronic device may also contain other essential elements including, but not limited to, any number of input/output means, processors, memories, etc., and all electronic devices which may implement the embodiments of the disclosure are within the protection scope of the embodiments of the disclosure.

An embodiment of the disclosure further provides a computer-readable storage medium having stored thereon a computer program including program instructions that, when executed by a processor of an electronic device, cause the processor to perform the calibration method according to any one of the above embodiments of the disclosure.

An embodiment of the disclosure further provides a processor configured to perform the calibration method described in any one of the above embodiments of the disclosure.

An embodiment of the disclosure further provides a computer program product including instructions, where the computer program product, when run on a computer, causes the computer to perform the calibration method according to any one of the above embodiments of the disclosure.

It will be recognized by those of ordinary skill in the art that the units and algorithm steps of the examples described in combination with the embodiments disclosed herein may be implemented in electronic hardware, or a combination of computer software and electronic hardware. Whether these functions are performed in hardware or software depends on the specific application and design constraints of the technical solution. The skilled artisan may use different methods for each specific application to implement the described functions, but such implementation should not be considered to go beyond the scope of the disclosure.

It will be apparent to those skilled in the art that for convenience and brevity of the description, the specific working processes of the above-described systems, apparatuses and units may refer to the corresponding processes in the foregoing method embodiments, and descriptions thereof will not be repeated herein. It will also be apparent to those skilled in the art that the embodiments of the disclosure are described with corresponding emphasis, and for convenience and brevity of the description, descriptions of the same or similar parts may not be repeated in different embodiments, therefore, the portions which are not described or not described in detail in certain embodiments may refer to the recordation of other embodiments.

In several embodiments provided in the disclosure, it should be understood that the disclosed systems, apparatus and methods may be implemented in other ways. For example, the apparatus embodiments as described above are merely illustrative, for example, the partitioning of the units is only a logical function partitioning, and other partitioning manners may be applied in actual implementation; for example, multiple units or components may be combined or integrated into another system, or some features may be ignored or may not be performed. On the other hand, the coupling or direct coupling or communication connection between the shown or discussed components may be implemented through some interface, may be indirect coupling or communication connection of apparatuses or units, and may be in electrical, mechanical or other forms.

The units illustrated as separate components may be or may not be physically separate, and the elements shown as units may be or may not be physical units, that is, may be located at one location or may be distributed across multiple network units. Part or all of the units may be selected according to actual needs to achieve the objectives of the solutions of the embodiments.

In addition, the functional units in the embodiments of the disclosure may be integrated in one processing unit, or the units may be present physically and separately, or two or more units may be integrated in one unit.

In the above embodiments, they may be implemented in whole or in part by software, hardware, firmware or any combination thereof. When implemented in software, they may be implemented in whole or in part in the form of a computer program product. The computer program product includes one or more computer instructions. When the computer program instructions are loaded and executed on a computer, a flow or function according to an embodiment of the disclosure is generated in whole or in part. The computer may be a general purpose computer, a special purpose computer, a computer network, or other programmable devices. The computer instructions may be stored in a computer-readable storage medium or transmitted through the computer-readable storage medium. The computer instructions may be transmitted from a web site, a computer, a server or a data center to another web site, computer, server or data center by wired (e.g., coaxial cable, optical fiber, Digital Subscriber Line (DSL)) or wireless (e.g., infrared, wireless, microwave, etc.) means. The computer-readable storage medium may be any available medium that the computer may access, or a data storage device such as a server, a data center, etc. containing one or more integrated available media. The available medium may be a magnetic medium (e.g., floppy disk, hard disk, magnetic tape), an optical medium (e.g., Digital Versatile Disc (DVD)), or a semiconductor medium (e.g., Solid State Disk (SSD)), etc.

It will be appreciated by those of ordinary skill in the art that all or part of the flow of the method of the above embodiments may be implemented, the flow may be completed by a computer program instructing related hardware, the program may be stored in a computer-readable storage medium, and the program, when being executed, may include the flow of the above method embodiments. The foregoing storage medium includes various media capable of storing program codes such as a ROM, a RAM, a magnetic disk, or an optical disk, etc.

1. A calibration method comprising:
acquiring at least two poses of an imaging device, and acquiring at least two pieces of first sampling data of an inertial sensor;
performing spline fitting process on the at least two poses to obtain a first spline curve, and performing spline fitting process on the at least two pieces of first sampling data to obtain a second spline curve; and
obtaining time-space deviation between the imaging device and the inertial sensor according to the first spline curve and the second spline curve, the time-space deviation comprising at least one of a pose conversion relationship or a sampling time offset.

2. The method of claim 1, wherein the time-space deviation comprises the pose conversion relationship; before obtaining the time-space deviation between the imaging device and the inertial sensor according to the first spline curve and the second spline curve, the method further comprises:
acquiring a preset reference pose conversion relationship; and
converting the second spline curve according to the preset reference pose conversion relationship to obtain a third spline curve,
wherein obtaining the time-space deviation between the imaging device and the inertial sensor according to the first spline curve and the second spline curve comprises:
obtaining a first difference according to the first spline curve and the third spline curve; and
determining the preset reference pose conversion relationship as the pose conversion relationship between the imaging device and the inertial sensor in a case that the first difference is less than or equal to a first threshold.

3. The method of claim 2, wherein the time-space deviation further comprises the sampling time offset; each point in the first spline curve carries time stamp information; before determining the preset reference pose conversion relationship as the pose conversion relationship between the imaging device and the inertial sensor in the case that the first difference is less than or equal to the first threshold, the method further comprises:
acquiring a preset first time offset; and
adding time stamp of a point in the third spline curve and the preset first time offset to obtain a fourth spline curve;
wherein obtaining the first difference according to the first spline curve and the third spline curve comprises: obtaining the first difference according to the fourth spline curve and the first spline curve; and
determining the preset reference pose conversion relationship as the pose conversion relationship between the imaging device and the inertial sensor in the case that the first difference is less than or equal to the first threshold comprises:
determining the preset reference pose conversion relationship as the pose conversion relationship between the imaging device and the inertial sensor and determining the preset first time offset as the sampling time offset between the imaging device and the inertial sensor, in the case that the first difference is less than or equal to the first threshold.

4. The method of claim 3, wherein the inertial sensor comprises an inertial measurement device; the at least two poses comprise at least two postures; the at least two pieces of first sampling data comprise at least two first angular velocities,
wherein performing spline fitting process on the at least two poses to obtain the first spline curve comprises:
obtaining at least two second angular velocities of the imaging device according to the at least two postures; and
performing spline fitting process on the at least two second angular velocities to obtain the first spline curve,
wherein performing spline fitting process on the at least two pieces of first sampling data to obtain the second spline curve comprises: performing spline fitting process on the at least two first angular velocities to obtain the second spline curve.

5. The method of claim 4, wherein the at least two poses further comprise at least two first positions; the at least two pieces of first sampling data further comprise at least two first accelerations;
before the operation of determining the preset reference pose conversion relationship as the pose conversion relationship between the imaging device and the inertial sensor and determining the preset first time offset as the sampling time offset between the imaging device and the inertial sensor in the case that the first difference is less than or equal to the first threshold, the method further comprises:
obtaining at least two second accelerations of the imaging device according to the at least two first positions;
performing spline fitting process on the at least two second accelerations to obtain a fifth spline curve, and performing spline fitting process on the at least two first accelerations to obtain a sixth spline curve; and
obtaining a second difference according to the fifth spline curve and the sixth spline curve,
wherein the operation of determining the preset reference pose conversion relationship as the pose conversion relationship between the imaging device and the inertial sensor and determining the preset first time offset as the sampling time offset between the imaging device and the inertial sensor in the case that the first difference is less than or equal to the first threshold comprises:
determining the preset reference pose conversion relationship as the pose conversion relationship between the imaging device and the inertial sensor and determining the preset first time offset as the sampling time offset between the imaging device and the inertial sensor, in a case that the first difference is less than or equal to the first threshold and the second difference is less than or equal to a second threshold.

6. The method of claim 3, wherein the inertial sensor comprises an inertial measurement device; the at least two poses comprise at least two second positions; the at least two pieces of first sampling data comprise at least two third accelerations,
wherein performing spline fitting process on the at least two poses to obtain the first spline curve comprises:
obtaining at least two fourth accelerations of the imaging device according to the at least two second positions; and
performing spline fitting process on the at least two fourth accelerations to obtain the first spline curve; and
wherein performing spline fitting process on the at least two pieces of first sampling data to obtain the second spline curve comprises:
performing spline fitting process on the at least two third accelerations to obtain the second spline curve.

7. The method of claim 6, wherein the at least two poses further comprise at least two second postures; the at least two pieces of first sampling data further comprise at least two third angular velocities;
before the operation of determining the preset reference pose conversion relationship as the pose conversion relationship between the imaging device and the inertial sensor and determining the preset first time offset as the sampling time offset between the imaging device and the inertial sensor in the case that the first difference is less than or equal to the first threshold, the method further comprises:
obtaining at least two fourth angular velocities of the imaging device according to the at least two second postures;
performing spline fitting process on the at least two fourth angular velocities to obtain a seventh spline curve, and performing spline fitting process on the at least two third angular velocities to obtain an eighth spline curve; and
obtaining a third difference according to the seventh spline curve and the eighth spline curve;
wherein the operation of determining the preset reference pose conversion relationship as the pose conversion relationship between the imaging device and the inertial sensor and determining the preset first time offset as the sampling time offset between the imaging device and the inertial sensor in the case that the first difference is less than or equal to the first threshold comprises:
determining the preset reference pose conversion relationship as the pose conversion relationship between the imaging device and the inertial sensor, and determining the preset first time offset as the sampling time offset between the imaging device and the inertial sensor, in a case that the first difference is less than or equal to the first threshold and the third difference is less than or equal to a third threshold.

8. The method of claim 1, wherein the time-space deviation comprises the sampling time offset; before obtaining the time-space deviation between the imaging device and the inertial sensor according to the first spline curve and the second spline curve, the method further comprises: acquiring a preset second time offset;
adding time stamp of a point in the first spline curve and the preset second time offset to obtain a ninth spline curve; and
obtaining a fourth difference according to the ninth spline curve and the second spline curve,
wherein obtaining the time-space deviation between the imaging device and the inertial sensor according to the first spline curve and the second spline curve comprises:
determining the preset second time offset as the sampling time offset between the imaging device and the inertial sensor in a case that the fourth difference is less than or equal to a fourth threshold.

9. The method of claim 1, wherein the imaging device and the inertial sensor belong to an electronic device, and the method further comprises:
acquiring at least two images using the imaging device;
obtaining at least two pieces of second sampling data of the inertial sensor during acquisition of the at least two images by the imaging device; and
obtaining a pose of the imaging device of the electronic device when the images are acquired, according to the at least two images, the at least two pieces of second sampling data and the time-space deviation.

10. A calibration apparatus, comprising:
a memory storing processor-executable instructions; and
a processor configured to execute the processor-executable instructions to perform operations of:
acquiring at least two poses of an imaging device, and acquire at least two pieces of first sampling data of an inertial sensor;
performing spline fitting process on the at least two poses to obtain a first spline curve, and performing spline fitting process on the at least two pieces of first sampling data to obtain a second spline curve; and
obtaining time-space deviation between the imaging device and the inertial sensor according to the first spline curve and the second spline curve, the time-space deviation comprising at least one of a pose conversion relationship or a sampling time offset.

11. The apparatus of claim 10, wherein the time-space deviation comprises the pose conversion relationship, and the processor is configured to execute the processor-executable instructions to perform further operations of: before obtaining the time-space deviation between the imaging device and the inertial sensor according to the first spline curve and the second spline curve,
acquiring a preset reference pose conversion relationship; and
converting the second spline curve according to the preset reference pose conversion relationship to obtain a third spline curve,
wherein obtaining the time-space deviation between the imaging device and the inertial sensor according to the first spline curve and the second spline curve comprises:
obtaining a first difference according to the first spline curve and the third spline curve; and
determining the preset reference pose conversion relationship as the pose conversion relationship between the imaging device and the inertial sensor in a case that the first difference is less than or equal to a first threshold.

12. The apparatus of claim 11, wherein the time-space deviation further comprises the sampling time offset, each point in the first spline curve carries time stamp information, and the processor is configured to execute the processor-executable instructions to perform further operations of: before determining the preset reference pose conversion relationship as the pose conversion relationship between the imaging device and the inertial sensor in the case that the first difference is less than or equal to the first threshold, acquiring a preset first time offset; and
adding time stamp of a point in the third spline curve and the preset first time offset to obtain a fourth spline curve,
wherein obtaining the first difference according to the first spline curve and the third spline curve comprises: obtaining the first difference according to the fourth spline curve and the first spline curve; and
determining the preset reference pose conversion relationship as the pose conversion relationship between the imaging device and the inertial sensor in the case that the first difference is less than or equal to the first threshold comprises:
determining the preset reference pose conversion relationship as the pose conversion relationship between the imaging device and the inertial sensor and determining the preset first time offset as the sampling time offset between the imaging device and the inertial sensor, in the case that the first difference is less than or equal to the first threshold.

13. The apparatus of claim 12, wherein the inertial sensor comprises an inertial measurement device; the at least two poses comprise at least two postures; the at least two pieces of first sampling data comprise at least two first angular velocities,
wherein performing spline fitting process on the at least two poses to obtain the first spline curve comprises:
obtaining at least two second angular velocities of the imaging device according to the at least two postures; and
performing spline fitting process on the at least two second angular velocities to obtain the first spline curve,
wherein performing spline fitting process on the at least two pieces of first sampling data to obtain the second spline curve comprises: performing spline fitting process on the at least two first angular velocities to obtain the second spline curve.

14. The apparatus of claim 13, wherein the at least two poses further comprise at least two first positions; the at least two pieces of first sampling data further comprise at least two first accelerations,
wherein the processor is configured to execute the processor-executable instructions to perform further operations of: before the preset reference pose conversion relationship is determined as the pose conversion relationship between the imaging device and the inertial sensor and the preset first time offset is determined as the sampling time offset between the imaging device and the inertial sensor in the case that the first difference is less than or equal to the first threshold,
obtaining at least two second accelerations of the imaging device according to the at least two first positions;
performing spline fitting process on the at least two second accelerations to obtain a fifth spline curve, and performing spline fitting process on the at least two first accelerations to obtain a sixth spline curve; and
obtaining a second difference according to the fifth spline curve and the sixth spline curve,
wherein the operation of determining the preset reference pose conversion relationship as the pose conversion relationship between the imaging device and the inertial sensor and determining the preset first time offset as the sampling time offset between the imaging device and the inertial sensor in the case that the first difference is less than or equal to the first threshold comprises:
determining the preset reference pose conversion relationship as the pose conversion relationship between the imaging device and the inertial sensor and determining the preset first time offset as the sampling time offset between the imaging device and the inertial sensor, in a case that the first difference is less than or equal to the first threshold and the second difference is less than or equal to a second threshold.

15. The apparatus of claim 12, wherein the inertial sensor comprises an inertial measurement device; the at least two poses comprise at least two second positions; the at least two pieces of first sampling data comprise at least two third accelerations,
wherein performing spline fitting process on the at least two poses to obtain the first spline curve comprises:
obtaining at least two fourth accelerations of the imaging device according to the at least two second positions; and
performing spline fitting process on the at least two fourth accelerations to obtain the first spline curve; and
wherein performing spline fitting process on the at least two pieces of first sampling data to obtain the second spline curve comprises:
performing spline fitting process on the at least two third accelerations to obtain the second spline curve.

16. The apparatus of claim 15, wherein the at least two poses further comprise at least two second postures; the at least two pieces of first sampling data further comprise at least two third angular velocities,
the processor is configured to execute the processor-executable instructions to perform further operations of: before the preset reference pose conversion relationship is determined as the pose conversion relationship between the imaging device and the inertial sensor and the preset first time offset is determined as the sampling time offset between the imaging device and the inertial sensor in the case that the first difference is less than or equal to the first threshold,
obtaining at least two fourth angular velocities of the imaging device according to the at least two second postures;
performing spline fitting process on the at least two fourth angular velocities to obtain a seventh spline curve, and performing spline fitting process on the at least two third angular velocities to obtain an eighth spline curve; and
obtaining a third difference according to the seventh spline curve and the eighth spline curve;
wherein the operation of determining the preset reference pose conversion relationship as the pose conversion relationship between the imaging device and the inertial sensor and determining the preset first time offset as the sampling time offset between the imaging device and the inertial sensor in the case that the first difference is less than or equal to the first threshold comprises:
determining the preset reference pose conversion relationship as the pose conversion relationship between the imaging device and the inertial sensor, and determining the preset first time offset as the sampling time offset between the imaging device and the inertial sensor, in a case that the first difference is less than or equal to the first threshold and the third difference is less than or equal to a third threshold.

17. The apparatus of claim 10, wherein the time-space deviation comprises the sampling time offset, and the processor is configured to execute the processor-executable instructions to perform further operations of: before obtaining the time-space deviation between the imaging device and the inertial sensor according to the first spline curve and the second spline curve,
acquiring a preset second time offset;
adding time stamp of a point in the first spline curve and the preset second time offset to obtain a ninth spline curve; and
obtaining a fourth difference according to the ninth spline curve and the second spline curve,
wherein obtaining the time-space deviation between the imaging device and the inertial sensor according to the first spline curve and the second spline curve comprises:
determining the preset second time offset as the sampling time offset between the imaging device and the inertial sensor in a case that the fourth difference is less than or equal to a fourth threshold.

18. The apparatus of claim 10, wherein the imaging device and the inertial sensor belong to the calibration apparatus, and the processor is configured to execute the processor-executable instructions to perform further operations of:
acquiring at least two images using the imaging device;
obtaining at least two pieces of second sampling data during acquisition of the at least two images by the imaging device; and
obtaining a pose of the imaging device when the images are acquired, according to the at least two images, the at least two pieces of second sampling data and the time-space deviation.

19. A non-transitory computer-readable storage medium having stored thereon computer-executable instructions that, when executed by a processor, cause the processor to perform operations of:
acquiring at least two poses of an imaging device, and acquiring at least two pieces of first sampling data of an inertial sensor;
performing spline fitting process on the at least two poses to obtain a first spline curve, and performing spline fitting process on the at least two pieces of first sampling data to obtain a second spline curve; and
obtaining time-space deviation between the imaging device and the inertial sensor according to the first spline curve and the second spline curve, the time-space deviation comprising at least one of a pose conversion relationship or a sampling time offset.

20. The non-transitory computer-readable storage medium of claim 19, wherein the time-space deviation comprises the pose conversion relationship; and when the computer-executable instructions are executed by the processor, the processor is caused to perform operations of: before obtaining the time-space deviation between the imaging device and the inertial sensor according to the first spline curve and the second spline curve, acquiring a preset reference pose conversion relationship; and
converting the second spline curve according to the preset reference pose conversion relationship to obtain a third spline curve,
wherein obtaining the time-space deviation between the imaging device and the inertial sensor according to the first spline curve and the second spline curve comprises:
obtaining a first difference according to the first spline curve and the third spline curve; and
determining the preset reference pose conversion relationship as the pose conversion relationship between the imaging device and the inertial sensor in a case that the first difference is less than or equal to a first threshold.
